(19) United States
(12) Patent Application Publication
(10) Pub. No.: US 2009/0281937 A1
(43) Pub. Date: Nov. 12, 2009

(54) System, Method and Apparatus for Associating a Credit Card Account with Sub-Account Codes

(75) Inventors: Shekhar Gupta, Overland Park, KS (US); Rich Schermerhorn, Overland Parks, KS (US); Victoria M. Toner, Sheboygan, WI (US); Johnny Hawkins, Kansas City, MO (US); Mike A. Roberts, Overland Park, KS (US)

Correspondence Address: SONNENSCHEIN NATH & ROSENTHAL LLP, P.O. BOX 061080, WACKER DRIVE STATION, WILLIS TOWER, CHICAGO, IL, 60606-1080, US

(73) Assignee: EMBARQ HOLDINGS COMPANY, LLC

(21) Appl. No.: 12/118,452

(22) Filed: May 9, 2008

(51) Int. Cl. G06Q 40/00

(52) U.S. Cl. 705/35

(57) ABSTRACT

A system, method, and apparatus for processing a purchase transaction includes receiving a purchase request associated with an item of purchase. The purchase request includes sub-account information associated with a sub-account of a credit account. The method further includes associating at least one approved purchase category with the sub-account information, and determining a purchase category of the item. If the purchase category of the item is not in an approved purchase category, the method further includes sending a notification message to an account holder associated with the credit account. Embodiments further include denying purchase of the item if the purchase category is not in an approved purchase category, and authorizing purchase of the item if the purchase category is in an approved purchase category.

### BACKGROUND

A credit card cardholder may wish to authorize other users to purchase items using the credit card account number associated with the cardholders To allow these users to purchase items, the cardholder must give a credit card associated with the credit card account number to the users. Alternately, the cardholder must give the credit card account number to the users. A disadvantage of this approach, however, is that each user will have access to the full credit amount associated with the credit card account number. In addition, the cardholder has little control of the type of items that can be purchased by each user. For example, a cardholder who is a parent may wish to give a credit card associated with a credit card account number to a child to allow the child to make purchases. However, the parent may wish to prevent the child from spending too much money or from buying items in unapproved categories. For example, the parent may wish to only allow the child to purchase items related to educational expenses while preventing the purchase of items from restaurants, convenience stores, or gas stations.

### BRIEF SUMMARY

A method for processing a purchase transaction according to one embodiments includes receiving a purchase request associated with an item of purchase. The purchase request includes sub-account information associated with a sub-account of a credit account. The method further includes associating at least one approved purchase category with the sub-account information, and determining a purchase category of the item. If the purchase category of the item is not in an approved purchase category, the method further includes sending a notification message to an account holder associated with the credit account. Some embodiments further include denying purchase of the item if the purchase category is not in an approved purchase category, and authorizing purchase of the item if the purchase category is in an approved purchase category.

An apparatus for processing a purchase transaction according to one embodiments include a processor(s) configured to receive a purchase request associated with an item of purchase The purchase request includes sub-account information associated with a sub-account of a credit account. The processor(s) is further configured to associate at least one approved purchase category with the sub-account information, and determine a purchase category of the item. If the purchase category is not in an approved purchase category, the processor(s) is configured to send a notification message to an account holder associated with the credit account. In some embodiments, the processor(s) is configured to deny purchase of the item if the purchase category is not in an approved purchase category, and authorize purchase of the item if the purchase category is in an approved purchase category.

### BRIEF DESCRIPTION OF THE DRAWINGS

Illustrative embodiments of the present invention are described in detail below with reference to the attached drawing figures, which are incorporated by reference herein and wherein:

FIG. 1A is an embodiment of an environment for associating sub-account codes with a credit account.

FIG. 1B is an embodiment of a system for processing a purchase transaction using a sub-account code associated with a credit account;

FIG. 2A is an embodiment of a procedure for associating a sub-account code(s) with a credit account;

FIG. 2B is an embodiment of a graphical user-interface configured to allow an account holder to manage sub-account information associated with a credit account;

FIG. 3 is an embodiment of a procedure for processing a purchase transaction using an sub-account code associated with a credit account; and

FIG. 4 is an embodiment of a communication device 600 for responding to a notification message by an account holder.

### DETAILED DESCRIPTION

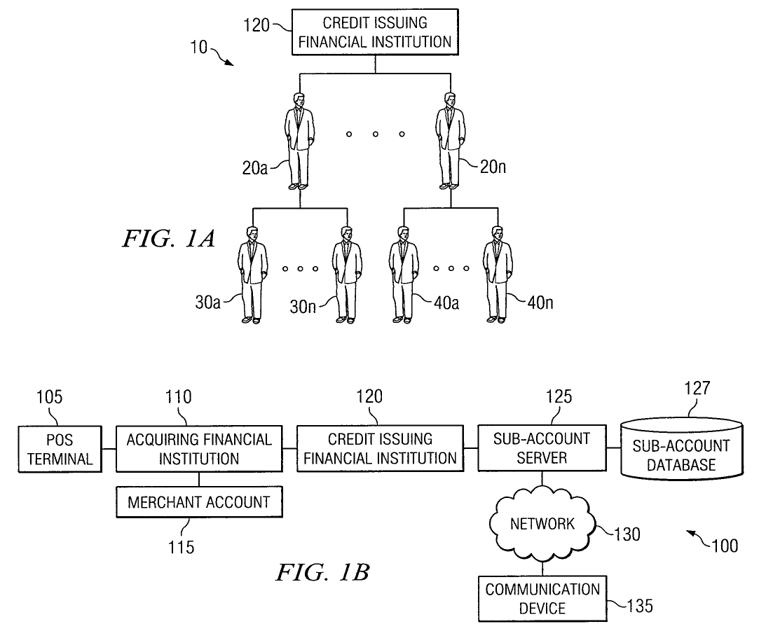

FIG. 1A is an embodiment of an environment 10 for associating sub-account codes with a credit account. The environment 10 includes a credit issuing financial institution 120 having a number of account holders 20a-20n associated with the credit issuing financial institution 120. Each of the account holders 20a-20n has a credit account with the credit issuing financial institution 120 having an associated credit account number. In some embodiments, the credit account is a credit card account having an associated credit card number. In various embodiments, the credit account associated with a particular account holder 20a is partitioned into a plurality of sub-accounts, each having an associated sub-account code. The account holder 20a may then set limits on purchase amounts and categories of allowed items for purchase for each sub-account. The account holder 20a can then provide each sub-account code to sub-account users 30a-30n. In still other embodiments, all of the account holders 20a-20n may each have credit accounts with associated sub-account codes that are provided to their respective sub-account code users 30a-30n and 40a-40n.

FIG. 1B is an embodiment of a system for processing a purchase transaction using a sub-account code associated with a credit account. A system 100 includes a point of sale (POS) terminal 105 in communication with an acquiring financial institution 110. In at least one embodiment, the POS terminal 105 is located at a merchant's premises. In at least one embodiment, the POS terminal is configured to accept a purchase attempt by a sub-account user 30a and send a purchase request to the acquiring financial institution 110. In at least one embodiment, the sub-account user 30a makes a purchase attempt using a credit card associated with an account holder 20a. In some embodiments, the POS terminal 105 is a telephone or mobile communication device associated with the sub-account user 30a. In still other embodiments, the POS terminal 105 is a personal computer. The acquiring financial institution 110 is a financial institution associated with the merchant that the merchant uses to process purchase transactions from customers using the POS terminal 105. A merchant account 115 associated with the merchant is maintained by the acquiring financial institution 110. The acquiring financial institution 110 is in communication with a credit issuing financial institution 120. The credit issuing financial institution 120 is a financial institution that has issued the credit account and associated sub-account by which the sub-account user 30a of the point of sale terminal 105 is attempting to make a purchase. The credit issuing financial institution 120 approves or denies purchase transaction attempts by users of credit accounts or sub-accounts that have been issued by the credit issuing financial institution 120.

The credit issuing financial institution 120 is in further communication with an sub-account server 125. The sub-account server 125 stores sub-account information related to one or more sub-accounts associated with a particular credit card account in a sub-account database 127. In accordance with various embodiments, a credit account number is associated with a particular account holder 20a. One or more individual sub-account codes are associated with the credit card account number and stored by the sub-account server 125. The account holder 20a may then assign each of the sub-account codes a portion or partition of the total credit allowed by the credit account. Accordingly, each sub-account code has a credit limit less than the credit limit associated with the credit account, and the sum of the credit limit associated with the sub-account codes is less than or equal to the credit limit associated with the credit card account. The sub-account server 125 further stores a personal identification number (PIN) associated with each sub-account code. The account holder 20a may then provide one or more of a credit account number, a sub-account code, and an associated PIN to one or more sub-account users 30a-30n. For example, the account holder 20a may be a parent and each sub-account user 30-30n that is provided with a sub-account code may be children of the parent. In another example, the account holder 20a may be a business and individual employees are provided with sub-account codes for approved purchase of approved items.

In some embodiments, the sub-account server 125 may further store sub-account information that includes a list of approved categories of items available for purchase using the sub-account code. For example, the account holder 20a may wish to allow a particular sub-account user 30a to buy only food or books while prohibiting all other purchases. In still other embodiments, the sub-account server 125 may further store a list of items prohibited for purchase for each sub-account code. For example, the account holder 20a may wish to prevent a particular sub-account user 30b from buying alcohol with the sub-account code. In still other embodiments, the sub-account server 125 may provide a list of approved businesses or website from which items may be purchased. In at least one embodiment, the sub-account server 125 is associated with a service provider.

In various embodiments, the sub-account server 125 stores credit account for a plurality of account holders 20a-20n. The sub-account server 125 further stores a sub-account information for a plurality of sub-accounts associated with each credit account. The sub-account information associated with each sub-account may include, for example, a sub-account code, a sub-account credit limit, a sub-account credit balance, and a sub-account approved purchase category list.

An example of a credit card account that has been partitioned into a plurality of sub-account codes is illustrated in TABLE 1.

TABLE 1
Credit Account #

| Sub-account code | PIN | Allowed Credit | Allowed Categories |
|---|---|---|---|
| Sub-Account Code 1 | PIN1 | $1000 | books, clothing |
| Sub-Account Code 2 | PIN2 | $500 | books, fuel, food |
| . | . | . | . |
| . | . | . | . |
| . | . | . | . |
| Sub-Account Code N | PINn | $1200 | medical expenses |

Returning now to FIG. 1B, in one embodiment, when a sub-account user 30a wants to make a purchase at the POS terminal 105, the user enters a credit account information such as a credit card number, a sub-account code associated with that credit account, and a PIN associated with the sub-account code into the POS terminal 105. In other embodiments, the sub-account 30a user may swipe a credit card at the POS terminal 105 to enter the credit account information. In response to receiving the credit card number, the sub-account code, and the PIN, the POS terminal 105 sends a purchase request to the acquiring financial institution 110. The acquiring financial institution 110 forwards the purchase request to the credit issuing financial institution 120. In response to receiving the purchase request, the credit issuing financial institution 120 accesses the sub-account server 125 to determine if the sub-account code and pin is valid, whether the sub-account code limit has been exceeded, and whether the purchase is in an approved purchase category. If the purchase is approved, the credit issuing financial institution 120 sends a purchase authorization to the acquiring financial institution 110, and the acquiring financial institution 110 sends an indication of the approval of the purchase to the POS terminal 105. After approval of the transaction, the credit issuing financial institution 120 sends a credit to the acquiring financial institution 110, and the acquiring financial institution 110 deposits the credit to the merchant account 115. If the purchase is not approved, a notification message is sent to the account holder 20a.

The system 100 further includes a communication device 135 in communication with the sub-account server 125 via a network 130. In at least one embodiment, the network 130 is the Internet. In at least one embodiment, the communication device 135 is a personal computer. In still other embodiments, the communication device 135 is a mobile device. The communication device 135 is configured to allow access to the sub-account server 125 by the account holder 20a. Using the communication device 135, the account holder 20a is able to configure and modify the sub-account code associated with the credit account. Examples of modifications that may be made to the sub-account code include changing the sub-account code, changing the PIN, setting purchase amount limits, adding credits to a particular sub-account code, setting categories of allowed purchases, setting categories of prohibited purchases, and disabling one or more accounts. In at least one embodiment, the communication device 135 is further configured to allow the account holder 20a to access the sub-account server 125 to provide a listing and/or a receipt of purchases associated with each sub-account code so that the account holder 20a can view the items purchased using each sub-account code. In at last one embodiment, the sub-account server 125 obtains the listing or receipt from the credit issuing financial institution 120.

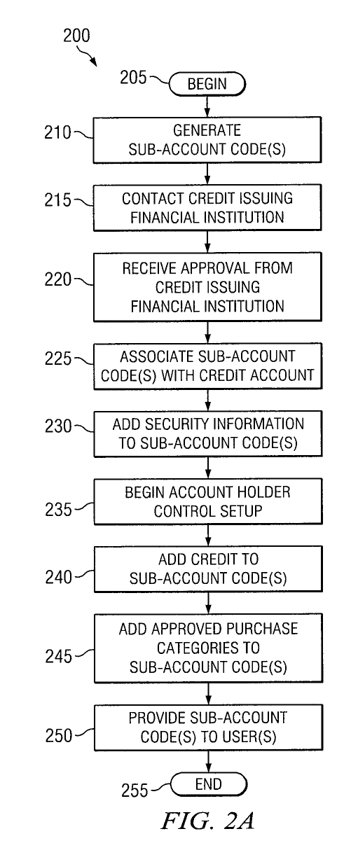

FIG. 2A is an embodiment of a procedure for associating a sub-account code(s) with a credit account. In step 205, the procedure 200 begins. In step 210, one or more sub-account codes are generated. In ach sub-account code is formed of a predetermined number of alphanumeric characters. In at least one embodiment, the sub-account code is selected by the account holder 20a. In still other embodiments, each sub-account code is generated by a service provider. In step 215, an account holder 20a having a credit account with the financial institution 120 contacts the credit issuing financial institution 120 and requests approval to associate one or more sub-account codes with the credit account. In step 220, the account holder 20a receives approval from the credit issuing financial institution 120 to associate the one or more sub-account codes with the credit card account number. The sub-account codes are then associated with the credit account in step 225.

In step 230, the account holder 20a adds security information to each of the sub-account codes. In at least one embodiment, adding security information to each sub-account code includes associating a PIN with each sub-account code. In still other embodiments, adding security information to each sub-account code includes adding fingerprint identification information of a sub-account user 30a. In step 235, an account holder control setup procedure is initiated. In at least one embodiment, the account holder control setup procedure is performed using the communication device 135. In at least one embodiment, the parental control procedure includes indicating one or more preferred methods of notification of account activity, such as via telephone, text message, or email. In step 240, the account holder 20a adds credit from the credit account to each of the sub-account codes. The credit includes a predetermined credit limit that may be used to purchase items using the sub-account code. In some embodiments, the predetermined credit limit is equal to an allowed monthly spending limit. In still other embodiment, the credit limit does not replenish until the account holder 20a adds more credits to the sub-account code. In step 245, the account holder 20a adds approved purchase categories to each of the sub-account codes to associate the approved purchase categories with the sub-account code. For example, the account holder 20a may be a parent who wishes to grant a sub-account user 30a access to purchase items for educational use only, such as books or tuition.

In step 250, the account holder 20a provides the one or more sub-account codes to one or more sub-account users 30a-30n. In at least one embodiment, the account holder 20a is a parent and the sub-account users 30a-30n to which sub-account codes are provided are the parent's children. In such an embodiment, the parent is able to set customized purchase limits and purchase categories for each child. In step 255 procedure 200 ends.

FIG. 2B is an embodiment of a graphical user-interface configured to allow an account holder 20a to manage sub-account information associated with a credit account. The embodiment of FIG. 2B illustrates an example operation of managing a particular sub-account code. The graphical user interface (GUI) 500 includes an account manager window 505 configured to allow the account holder to manage and change sub-account information associated with one or more sub-accounts. The GUI 500 includes a sub-account code entry field 510 that allows an account holder 20a to enter of change the sub-account code associated with a particular sub-account. In the illustrated embodiment, the sub-account code has been configured with an account code of 001. The GUI 500 further includes a sub-account name entry field 515 that allows the account holder 20a to enter a sub-account name associated with the sub-account. In the illustrated embodiment, the sub-account name field has been configured with a sub-account name of “DAUGHTER.” The GUI 500 further includes a sub-account limit entry field 520a that allows the account holder 20a to specify a purchase limit for the sub-account, and a sub-account limit selection dialog 520b that allows the account holder 20a to select a predefined purchase limit for the sub-account. In the illustrated embodiment, a sub-account purchase limit of $250 has been selected using the sub-account limit selection dialog 520. The GUI 500 still further includes a sub-account purchase category selection dialog 525 that allows the account holder 20a to select the allowed purchase categories for the sub-account. In the illustrated embodiment, the allows purchase categories of fuel, clothing, and books has been selected using the sub-account purchase category selection dialog 525. The GUI further includes a sub-account notification dialog 530 that allows the account holder 20a to select the manner by which he wishes to be notified of purchase activity involving the sub-account. The sub-account notification dialog 530 allows the account holder 20a to select notification by email and entry of an email address and/or notification via text message and entry of a phone number for the text message. In the illustrated embodiment, the account holder 20a has selected that he wishes to be notified via text message at the phone number 555-555-5555.

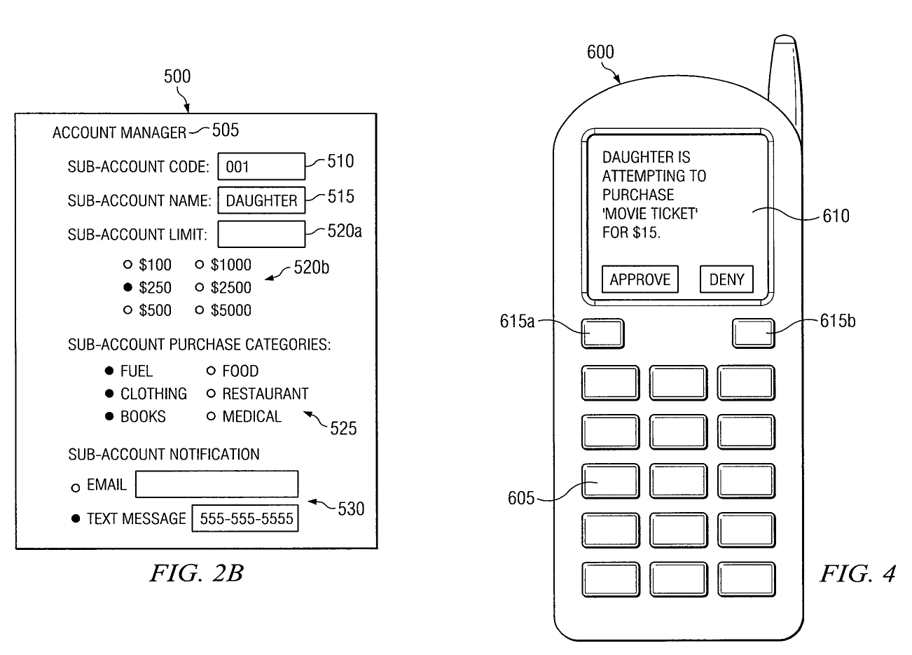

FIG. 3 is an embodiment of a procedure for processing a purchase transaction using an sub-account code associated with a credit account. In step 305 the procedure begins. In step 310, a sub-account user 30a initiates a purchase of an item at POS terminal 105. In still other embodiments, the sub-account user 30a may initiate the purchase using a telephone or a computer. In step 315, the sub-account user 30a enters sub-account information associated with the sub-account. In at least one embodiment, the sub-account code information includes a credit account number, an associated sub-account code, and a PIN.

In step 320, the point of sale terminal 105 sends a purchase request including the sub-account information to the acquiring financial institution 110. In step 325, the acquiring financial institution 110 forwards the purchase request to the credit issuing financial institution 120. In step 330, the credit issuing financial institution 120 sends a sub-account access request including the sub-account information to the sub-account server 125. In step 340, the sub-account server 125 determines the validity of the sub-account code and PIN. In step 345, if the sub-account code and pin is determined to be invalid, the process continues to step 350. In step 350, a purchase rejection message is sent to the POS terminal 105 indicating that the sub-account code and PIN is invalid. In step 355, the purchase is denied and in step 410 the procedure 300 ends.

If in step 345, it is determined that the sub-account code and PIN is valid, the procedure 300 continues to step 360. At step 360, a purchase category of the purchase item is checked and/or determined. In step 365, if it is determined that the item to be purchased is not in an approved purchase category, the procedure 300 continues to step 370. In step 370, a notification message is sent to the account holder 20a indicating that there is an attempt to purchase an item that is not in an approved purchase category. The notification message may further include an identification, and purchase category, and/or purchase price of the item that is attempted to be purchased. In step 375, a purchase rejection message is sent to the point of sale terminal 105. In step 380, the purchase is denied and the procedure 300 ends at step 410. In an alternate embodiment, the notification message can include a purchase approval request to prompt the account holder 20a to authorize the purchase despite the fact that it is in an approved purchase category. If the account holder 20a approves the purchase in response to the prompting, the procedure 300 continues to step 385.

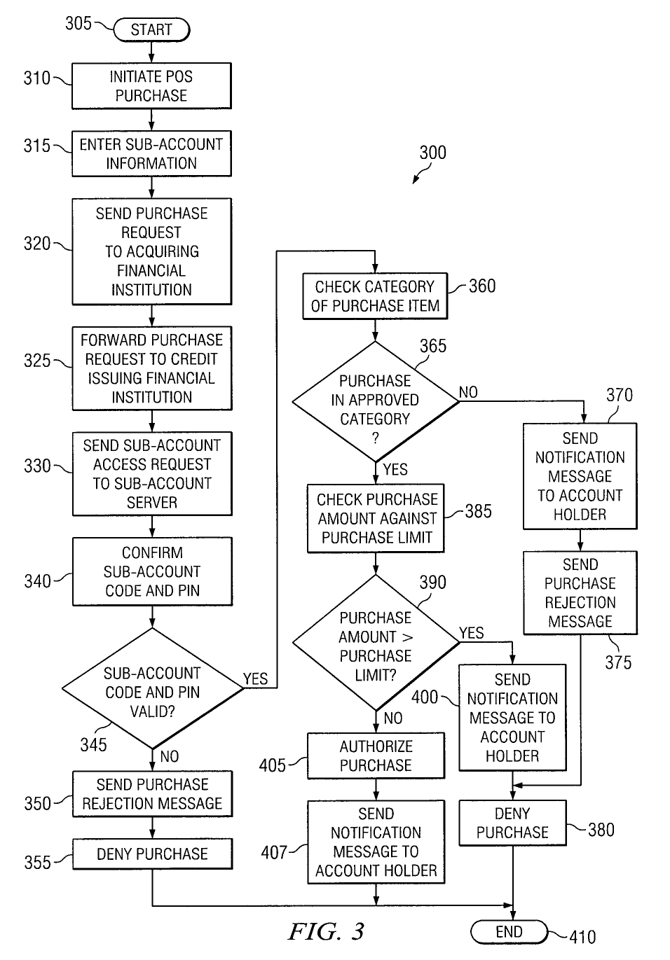

FIG. 4 is an embodiment of a communication device 600 for responding to a notification message by an account holder 20a. In at least one embodiment, the communication device 600 includes a wireless handset. The communication device 600 includes a keypad 605 and a display screen 610. The communication device 600 further includes interface keys 615a and 615b. In the embodiment of FIG. 4, the communication device 600 has received a notification message including a purchase approval request that a sub-account user 30a is attempting to make a purchase of an item in an unapproved category. In the example illustrated in FIG. 4, the display screen 610 displays a message indicating that ‘DAUGHTER IS ATTEMPTING TO PURCHASE MOVIE TICKETS FOR $15.’ The communication device 600 further displays a prompt to the account holder 20a allowing the account hold to either approve of deny the purchase. If the account holder 20a presses interface key 615a, the communication device 600 wilt send a purchase approval message to the sub-account server 125. The account holder 20a presses interface key 615b, the communication device 600 will send a purchase denial message to the sub-account server 125.

Returning now to FIG. 3, if it is determined in step 365 that the purchase item is in an approved purchase category, the procedure 300 continues to step 385. In step 385, the purchase amount of the item is checked against a purchase limit determined by the account holder 20a and associated with the sub-account code. In step 395, if it is determined that the purchase amount is greater than the purchase limit, the procedure continues to step 400. In step 400, a notification message is sent to the POS terminal 105 indicating that the purchase amount is greater than the purchase limit and the procedure continues to step 380 in which the purchase is denied, and to step 410 at which the procedure 300 ends. In an alternate embodiment, the notification message can include a prompt to allow the account holder 20a to approve the purchase despite the fact that it is greater than the purchase limit. If the account holder 20a approves the purchase in response to the prompting, the procedure 300 continues to step 405.

If it is determined in step 390 that the purchase amount is not greater than the purchase limit, the purchase is authorized in step 405. Step 405 includes sending a purchase authorization from the sub-account server 125 to the credit issuing financial institution 120, the credit issuing financial institution 120 forwarding the purchase authorization to the acquiring financial institution 110, and the acquiring financial institution 110 sending a confirmation that the item has been authorized for purchase to the POS terminal 105. In an optional step 407, a purchase notification message is sent to the account holder 20a indicating that the item has been purchased. The purchase notification message may include a receipt and/or further purchase details such as cost and an identification of the item purchase. In step 410, the procedure 300 ends.

The illustrative embodiments can take the form of an entirely hardware embodiment, an entirely software embodiment or an embodiment containing both hardware and software elements. Furthermore, the illustrative embodiments can take the form of a computer program product accessible from a computer-usable or computer-readable medium providing program code for use by or in connection with a computer or any instruction execution system. For the purposes of this description, a computer-usable or computer-readable medium can be any tangible apparatus that can contain, store, communicate, propagate, or transport the program for use by or in connection with the instruction execution system, apparatus, or device. In various embodiments, the sub-account server 125 includes one or more processors operable to execute computer executable instructions from a computer-usable or computer-readable medium to perform the various capabilities of the sub-account server 125 described herein.

The computer-usable or computer-readable medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

Further, a computer storage medium may contain or store a computer-readable program code such that when the computer-readable program code is executed on a computer, the execution of this computer-readable program code causes the computer to transmit another computer-readable program code over a communication link. This communication link may use a medium that is, for example without limitation, physical or wireless.

The previous detailed description is of a small number of embodiments for implementing the invention and is not intended to be limiting in scope. One of skill in this art will immediately envisage the methods and variations used to implement this invention in other areas than those described in detail. The following claims set forth a number of the embodiments of the invention disclosed with greater particularity.

1. A method for processing a purchase transaction comprising:
receiving a purchase request associated with an item of purchase at a server, the purchase request including sub-account information associated with a sub-account of one or more sub-accounts associated with the credit account of a credit card, the sub-account information for each of the one or more sub-accounts being stored in a database accessible by the server for managing purchases utilizing the credit account, at least one approved purchase category being associated with the sub-account information;
determining a purchase category of the item; and
if the purchase category is not in an approved purchase category sending a notification message from the server to an account holder associated with the credit account.

2. The method of claim 1, further comprising:
denying purchase of the item if the purchase category is not in an approved purchase category, if a business associated with the purchase request is prohibited for the sub-account, or if a pin associated with the sub-account is not correct.

3. The method of claim 1 further comprising:
authorizing purchase of the item if the purchase category is in an approved purchase category, wherein the database is updated in response to purchase of the item.

4. The method of claim 1, wherein the generating further comprises:
associating a predetermined purchase limit with the one or more sub-accounts;
associating a pin number with each of the one or more sub-accounts; and
associating one or more approved purchase categories and one or more approved businesses with each of the one or more sub-accounts.

5. The method of claim 4 further comprising:
determining if a purchase amount of the item is greater than the predetermined purchase limit; and
if the purchase amount is greater than the predetermined purchase limit:
sending a notification message to the account holder associated with the credit card account number; and
denying purchase of the item.

6. The method of claim 4 further comprising:
determining if a purchase amount of the item is greater than the predetermined purchase limit; and
if the purchase amount is not greater than the predetermined purchase limit:
authorizing purchase of the item.

7. The method of claim 1 further comprising:
wherein the notification message further includes a purchase approval request.

8. The method of claim 7 further comprising:
prompting the account holder for approval of the purchase in response to receiving the purchase approval request; and
authorizing a real-time purchase of the item if the account holder approves the purchase.

9. The method of claim 1 further comprising:
sending a purchase notification message to the account holder if the item is authorized for purchase.

10. The method of claim 1, further comprising providing a user interface configured to allow the account holder to change at least one of the at least one approved purchased category and an approved purchase limit associated with the sub-account.

11. An apparatus for processing a purchase transaction comprising:
at least one processor, the at least one processor configured to:
generate one or more sub-accounts associated with a credit account of a credit card, the one or more sub-accounts including a sub-account, the one or more sub-accounts including sub-account information, at least one approved purchase category being associated with the sub-account information for each of the one or more sub-accounts;
receive a purchase request associated with an item of purchase, the purchase request including the sub-account information associated with a sub-account of a credit account;
determine a purchase category of the item; and
if the purchase category is not in an approved purchase category:
send a notification message to an account holder associated with the credit account.

12. The apparatus of claim 11, wherein the at least one processor is further configured to:
deny purchase of the item if the purchase category is not in an approved purchase category, if a business associated with the purchase request is prohibited for the sub-account, or if a pin or a fingerprint associated with the sub-account is not correct.

13. The apparatus of claim 11, wherein the at least one processor is further configured to:
authorize purchase of the item if the purchase category is in an approved purchase category:

14. The apparatus of claim 13, wherein the sub-account information includes a predetermined purchase limit associated with the one or more sub-accounts, a pin number associated with each of the one or more sub-accounts, and one or more approved purchase categories and one or more approved businesses associated with each of the one or more sub-accounts.

15. The apparatus of claim 14, wherein the at least one processor is further configured to:
determine if a purchase amount of the item is greater than the predetermined purchase limit; and
if the purchase amount is greater than the predetermined purchase limit:
send a notification message to the account holder associated with the credit card account number; and
deny purchase of the item.

16. The apparatus of claim 14, wherein the at least one processor is further configured to:
determine if a purchase amount of the item is greater than the predetermined purchase limit; and
if the purchase amount is not greater than the predetermined purchase limit:
authorize purchase of the item.

17. The apparatus of claim 11, wherein the notification message further includes a purchase approval request.

18. The apparatus of claim 17, wherein the at least one processor is further configured to:
prompt the account holder for approval of the purchase in real-time though a wireless communication; and
authorize purchase of the item if the account holder approves the purchase.

19. The apparatus of claim 18, wherein the at least one processor is further configured to:
immediately send a purchase notification message to the account holder if the item is authorized for purchase.

20. The apparatus of claim 14, wherein the at least one processor is further configured to:
provide a user interface configured to allow the account holder to change the sub-account information.
